(19) United States
(12) Patent Application Publication
(10) Pub. No.: US 2024/0246207 A1
(43) Pub. Date: Jul. 25, 2024

(54) Press Ring, Pressing Tool and Adapter Elements

(71) Applicant: Novopress GmbH Pressen und Presswerkzeuge & Co. KG, Neuss (DE)

(72) Inventors: Martin Bungter, Mönchengladbach (DE); Stephan Krämer, Oberhausen (DE)

(21) Appl. No.: 18/289,919

(22) PCT Filed: May 12, 2022
(86) PCT No.: PCT/EP2022/062973

§ 371 Date: Nov. 8, 2023

(30) Foreign Application Priority Data
May 12, 2021 (DE) 20 2021 102 613.8

(51) Int. Cl. B25B 27/02; B21D 39/04

(52) U.S. Cl. CPC B25B 27/02; B21D 39/04

(57) ABSTRACT

Press ring, pressing tool, adapter element for a pressing tool, adapter element for a press ring, pressing device having an electric drive and a pressing tool, system having an adapter element for pressing a press fitting by means of a press ring. Here, the press ring has at least two different pairs of receiving elements for connection to a corresponding pair of connecting elements of different pressing tools. The pressing tool has at least two different pairs of connecting elements for connection to respectively one corresponding pair of receiving elements of different press rings. The adapter elements for a pressing tool and press ring each have a pair of connecting elements for connection to a corresponding pair of connecting elements of a pressing tool and a pair of connecting elements for connection to a corresponding pair of receiving elements of a press ring.

### CROSS REFERENCE TO RELATED APPLICATIONS

This application is the United States national phase of International Patent Application No. PCT/EP2022/062973 filed May 12, 2022, and claims priority to German Patent Application No. 20 2021 102 613.8 filed May 12, 2021, the disclosures of which are hereby incorporated by reference in their entireties.

### BACKGROUND OF THE INVENTION

### Field of the Invention

The present invention relates to a press ring, a pressing tool, and an adapter element for a pressing tool as well as an adapter element for a press ring, and a pressing device having an electric drive for a pressing tool according to the invention, and a system having an adapter element according to the invention for a pressing tool as well as a system having an adapter element according to the invention for a press ring, for pressing a press fitting by means of a press ring.

### Description of Related Art

When pressing of press fittings, in particular for the connection of tubular components by means of cold forming, it is known to use a press ring. The press ring has at least two segments which are connected to each other in a hinge-like manner and in turn each have receiving elements for connection to a pressing tool. The press ring is connected to a pressing device by means of a pressing tool, which in turn has pressing jaws with connecting elements. This allows a mechanical pressing force to be applied by the pressing device to the press ring for pressing the press fitting. In particular, this is an electrohydraulic pressing device by which the pressing jaws of the pressing tool are moved towards each other, the movement of the pressing jaws being transmitted to the press ring to close the press ring, as a result of which a reduction of an inner radius of the press ring occurs, by which the press fitting abutting the inner radius of the press ring is pressed.

There are different press rings for different press fittings, which have an inner radius suitable for the respective press fitting. The pressing tool must also be suitably matched to the respective press ring and press fitting, respectively. On the one hand, this matching must be geometrically correct, i.e. the closing distance of the pressing tool must be matched to the closing distance of the press ring. On the other hand, the pressing tool must be able to transmit the necessary closing force to be able to close the press ring on the press fitting.

Furthermore, the shape, dimension and position of the receiving elements of the press ring and the connecting elements of the pressing tool must be matched to each other in such a way that a connection can be established or maintained between the pressing tool and the press ring until the closing force required for pressing the press fitting has been transmitted.

A press ring, which for example has a connecting bolt arranged on each of its opposing segments as a receiving element, can be connected to a pressing tool which has suitable undercuts on its two pressing jaws as a connecting element, which are brought into engagement with the connecting bolts for connection.

Another example of matching receiving or connecting elements of a press ring or pressing tool are receiving elements of a press ring having spherical recesses and a connecting element of a pressing tool having correspondingly suitable spherical segments.

These are only two examples from a plurality of existing configurations of receiving or connecting elements for suitable press ring and pressing tool combinations.

To ensure complete and damage-free pressing of a press fitting, the press fitting, the press ring and the pressing tool must therefore be matched to each other both geometrically with regard to the closing paths and/or with regard to the closing force applied to the press fitting, and in particular with regard to the shape, dimension and position of the respective receiving or connecting elements of the press ring and pressing tool combination used.

However, the receiving elements of existing press rings can only be suitably connected to a specific pair of connecting elements of a corresponding pressing tool for pressing a press fitting. This severely restricts compatibility or usability with press fittings, press rings and pressing tools equipped with various receiving or connecting elements.

### SUMMARY OF THE INVENTION

It is an object of the present invention to provide a press ring, a pressing tool and an adapter element for a pressing tool or a press ring that increase the compatibility or usability of different press rings and pressing tools.

The object is achieved by a press ring as described herein, a pressing tool as described herein, an adapter element for a pressing tool as described herein, an adapter element for a press ring as described herein, and a pressing device as described herein, a system as described herein, and a system as described herein.

A first aspect of the present invention relates to a press ring for pressing a press fitting. In this case, the press ring has at least two segments movably connected to one another, the segments being movable from an open position to a closed position.

Further, the press ring comprises at least a first pair of receiving elements and a second pair of receiving elements, the first pair of receiving elements being arranged on a first segment and a last segment of the press ring and each configured for connection to a pair of connecting elements of a first pressing tool.

Furthermore, the second pair of receiving elements is arranged on the first segment and the last segment of the press ring and are each configured for connection to a pair of connecting elements of a second pressing tool.

Here, according to the invention, the first pair of receiving elements is different from the second pair of receiving elements.

This allows the press ring to be connected to more than one pressing tool, in particular to two different pressing tools having different pairs of connecting elements, for pressing a press fitting, thereby ensuring compatibility of the press ring with more than one pressing tool and thus usability with different types of pressing tools.

Preferably, the number of different pairs of receiving elements is more than two. This makes it possible to connect the press ring with more than two types of connecting elements of pressing tools, which further increases the usability of the press ring. Preferably, the first pair of receiving elements are connecting bolts and/or the second pair of receiving elements are recesses.

Preferably, the first pair of receiving elements are recesses and the second pair of receiving elements are recesses.

Preferably, the recess of the first pair of receiving elements is a spherical or partially spherical recess and/or the recess of the second pair of receiving elements is a disc-shaped recess or vice versa. Alternatively, the second pair of receiving elements is also a spherical or partially spherical recess.

Preferably, the recess of the first pair of receiving elements is arranged separately from the recess of the second pair of receiving elements.

Preferably, the recess of the first pair of receiving elements is arranged in the recess of the second pair of receiving elements. Here, the recess of the first pair of receiving elements in particular has a smaller dimension than the recess of the second pair of receiving elements.

Preferably, the recess of the first pair of receiving elements and the recess of the second pair of receiving elements have a common lateral boundary, so that when the first pair of receiving elements is connected to a first pair of connecting elements of a pressing tool, the common lateral boundary serves as a movement limitation for the pressing tool, whereas, in particular when the second pair of receiving elements is connected to a first pair of connecting elements of a pressing tool, the pressing tool and the press ring can be rotated relative to one another.

Preferably, the press ring is a press collar, which in particular has more than two segments.

A second aspect of the present invention relates to a pressing tool for pressing a press fitting by means of a press ring. Here, the pressing tool has two pressing jaws which can be moved towards each other from an open position to a closed position for pressing.

Furthermore, the pressing jaws comprise at least a first pair of connecting elements and a second pair of connecting elements.

Furthermore, the first pair of connecting elements are each configured for connection to a pair of receiving elements of a first press ring, and the second pair of connecting elements are each configured for connection to a pair of receiving elements of a second press ring, which is different from the first press ring.

Here, according to the invention, the first pair of connecting elements is different from the second pair of connecting elements.

As a result, the pressing tool can be connected to more than one type of receiving element of a press ring for pressing a press fitting and the usability of the pressing tool with different press rings is ensured.

Preferably, the number of different pairs of receiving elements is more than two. This further increases the usability of the pressing tool to more than two different types of receiving elements or press rings.

Preferably, at least one and in particular the first pair of connecting elements are undercuts for connection to connecting bolts of a press ring.

Preferably, at least one pair and in particular the second pair of connecting elements are ball segments or spherical segments for connection to recesses of a press ring.

Preferably, the undercut of the first pair of connecting elements is formed in the ball segment or spherical segment of the second pair of connecting elements. Thus, the ball segment or spherical segment has a deviation from a spherical shape to form the undercut.

A third aspect of the present invention relates to an adapter element for a pressing tool. Here, the adapter element comprises a first pair of connecting elements for connection to a pair of connecting elements of a pressing tool.

Furthermore, the adapter element comprises a second pair of connecting elements for connection to a corresponding pair of receiving elements of a press ring, so that when the adapter element is connected to the pressing tool on the one hand and the press ring on the other hand, when the pressing jaws are moved, this movement is transmitted to the adapter element and the press ring can be moved from an open position to a closed position for pressing a press fitting. Here, according to the invention, the first pair of connecting elements is different from the second pair of connecting elements.

By means of the adapter element, the pressing tool, which has only one pair of connecting elements for connection to a corresponding pair of receiving elements of a first press ring, can now be connected to a different pair of receiving elements of another press ring for pressing a press fitting. This ensures that the pressing tool can be combined with more than one press ring.

Preferably, the adapter element has two separate components, the first component being connectable to the first connecting element of the pair of connecting elements of the pressing tool, and the second component being connectable to the second connecting element of the pair of connecting elements of the pressing tool.

Preferably, the first pair of receiving elements are recesses and/or the second pair of connecting elements are undercuts.

A fourth aspect of the present invention relates to an adapter element for a press ring. Here, the adapter element comprises a first pair of connecting elements for connection to a corresponding pair of connecting elements of a pressing tool.

Furthermore, the adapter element comprises a second pair of connecting elements for connection to a pair of receiving elements of a press ring, so that when the adapter element is connected to the pressing tool on the one hand and the press ring on the other hand, when the pressing jaws are moved, this movement is transmitted to the adapter element and the press ring can be moved from an open position to a closed position for pressing a press fitting. Here, according to the invention, the first pair of connecting elements is different from the second pair of connecting elements.

By means of the adapter element, the press ring, which has only one pair of receiving elements for connection to a corresponding pair of connecting elements of a first pressing tool, can now be connected to a different pair of connecting elements of another pressing tool for pressing a press fitting. This ensures that the press ring can be used with more than one pressing tool.

Preferably, the adapter element has two separate components, the first component being connectable to the first receiving element of the pair of receiving elements of the press ring, and the second component being connectable to the second receiving element of the pair of receiving elements of the press ring.

Preferably, the first pair of receiving elements are connecting bolts and/or the second pair of connecting elements are ball segments or spherical segments or vice versa.

A fifth aspect of the present invention relates to a pressing device having an electric drive and a pressing tool according to the invention, as described above. Here, the pressing tool is in particular detachably connected to the drive for moving the pressing jaws of the pressing tool.

A sixth aspect of the present invention relates to a system having a press ring according to the invention, as described above, and a pressing device having a drive.

A seventh aspect of the present invention relates to a system having an adapter element according to the invention, as described above, and a press ring and a pressing device.

### BRIEF DESCRIPTION OF THE DRAWINGS

The terms Fig., Figs., Figure, and Figures are used interchangeably in the specification to refer to the corresponding figures in the drawings.

In the following, the invention is described in more detail by means of preferred embodiments with reference to the accompanying drawings.

In the Figures:

FIG. 1 shows a press ring according to the invention and a first and a second suitable pressing tool,

FIG. 1A shows the press ring according to the invention connected to the first suitable pressing tool,

FIG. 1B shows the press ring according to the invention connected to the second suitable pressing tool,

FIG. 2 shows a further embodiment of a press ring according to the invention and a first and a second suitable pressing tool,

FIG. 2A shows the press ring according to the embodiment shown in FIG. 2 connected to the first suitable pressing tool,

FIG. 2B shows the press ring according to the embodiment shown in FIG. 2 connected to the second suitable pressing tool,

FIG. 3 shows a pressing tool according to the invention,

FIG. 4A shows an adapter element according to the invention for a pressing tool with a suitable pressing tool,

FIG. 4B shows an adapter element according to the invention for a press ring with a suitable press ring.

### DESCRIPTION OF THE INVENTION

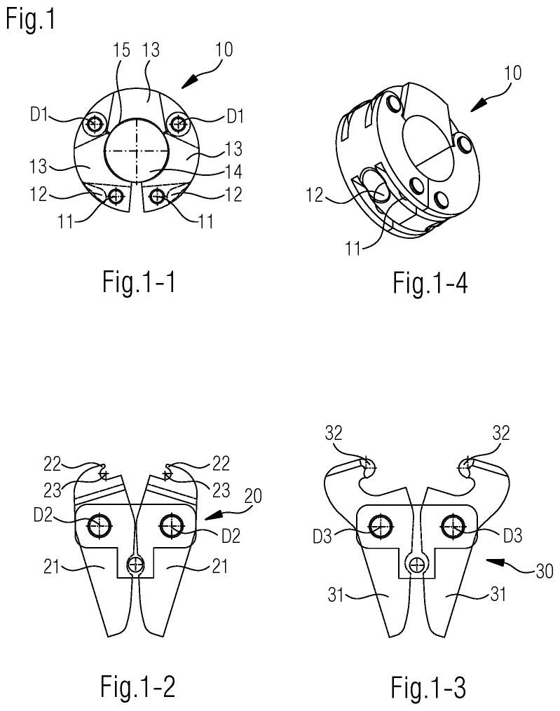

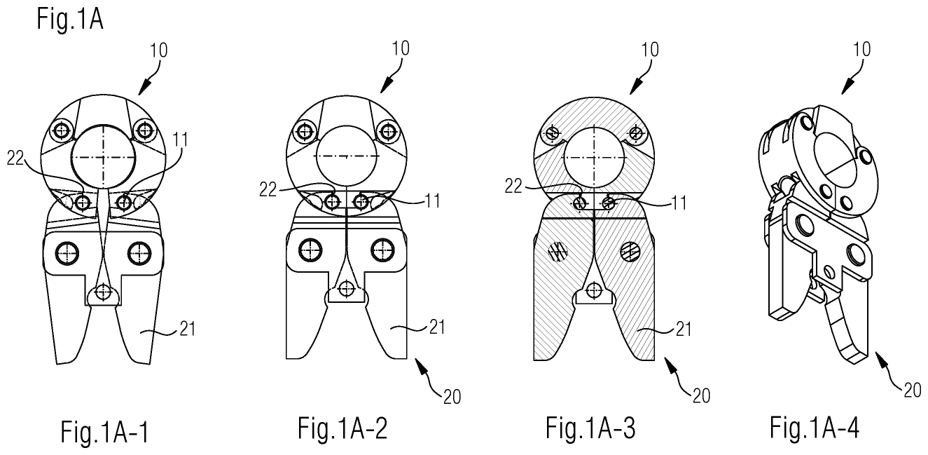

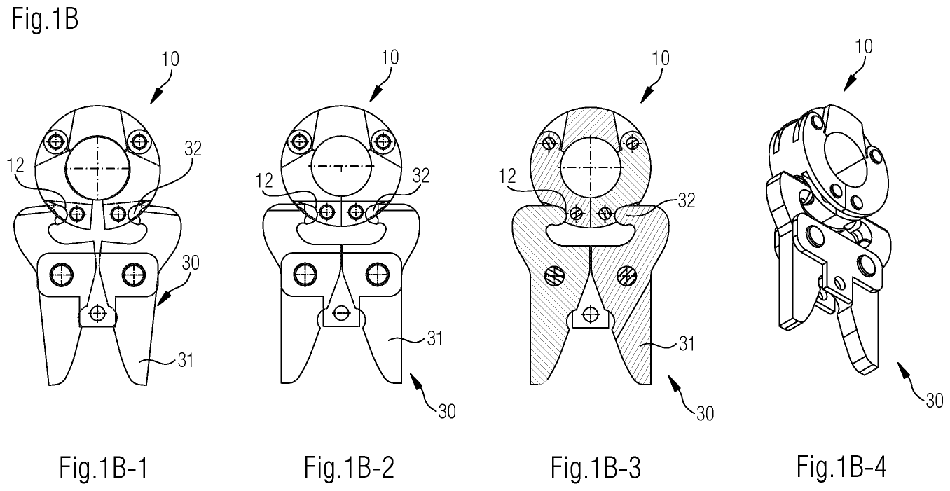

FIG. 1 shows a press ring 10 according to the invention for pressing a press fitting 15 with a suitable first pressing tool 20 and a suitable second pressing tool 30 in an open position, i.e. in a state before pressing the press fitting 15, in which press ring 10 is set around press fitting 15 in a force-free manner. Press ring 10 has several segments 13, which are rotatably connected to each other about the axes of rotation D1 and form an inner opening 14. A first pair of receiving elements 11 and a second pair of receiving elements 12 are arranged on each of the first and last segment 13 of press ring 10. In this case, the first pair of receiving elements 11 of the embodiment of the press ring shown in FIG. 1 is formed as a connecting bolt, and the second pair of receiving elements 12 is formed as a spherical recess of press ring 10.

The first and second pair of receiving elements 11, 12 of press ring 10, as shown in FIG. 1, are each arranged terminally in the segments 13 of the press ring at offset positions. In particular, the second pair of receiving elements 12 is arranged between two respective engagements on the respective connecting bolts of the first pair of receiving elements 11.

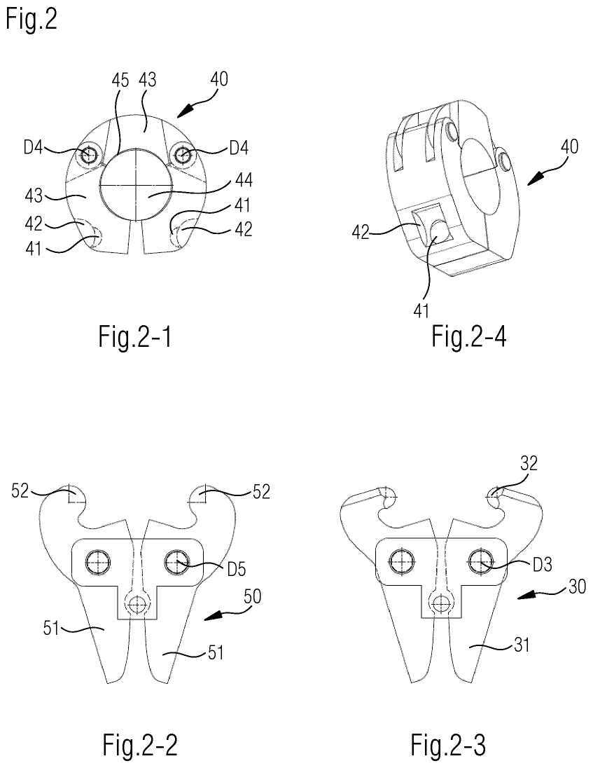

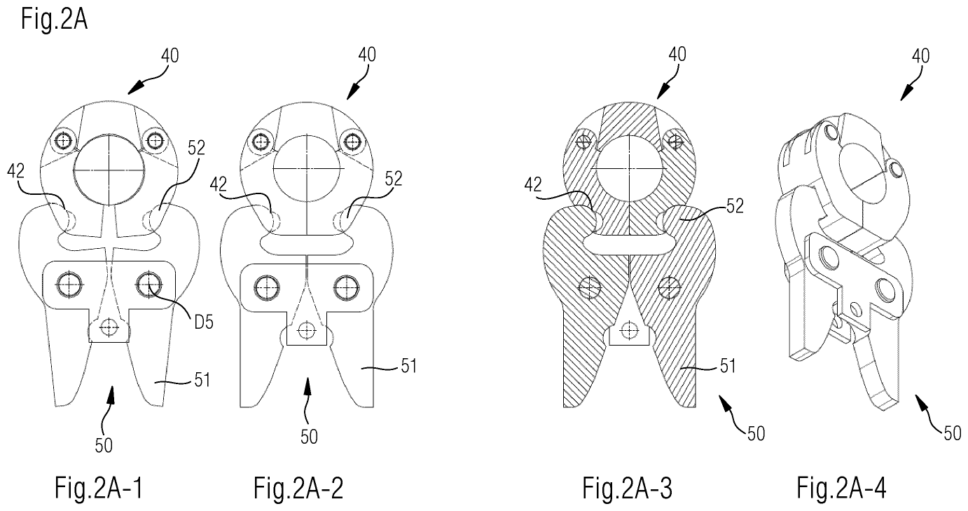

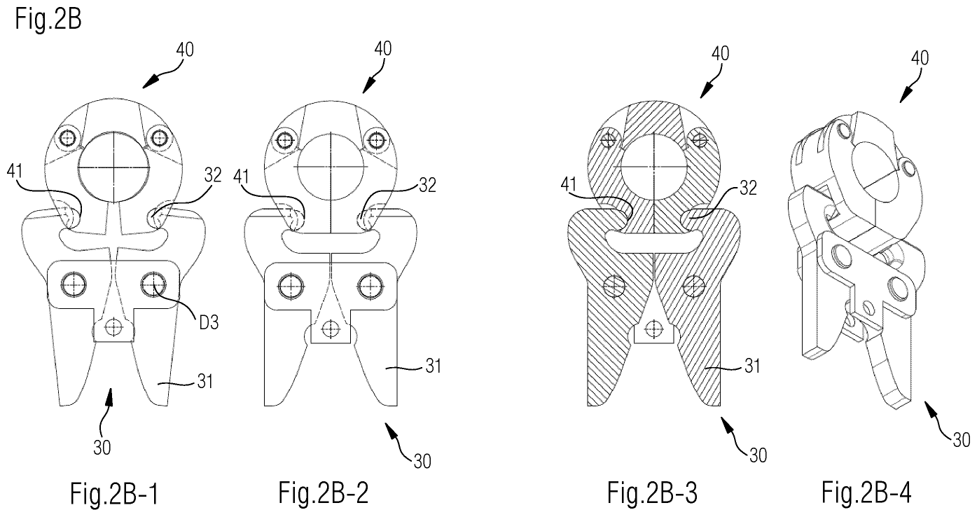

Furthermore, FIG. 1-2 shows a first pressing tool 20 having two pressing jaws 21, which are rotatably arranged about the respective axes of rotation D2. The first pressing tool 20 further comprises a pair of connecting elements 22 designed as an undercut 23. The connecting elements 22 of the first pressing tool are designed in terms of their shape, dimension and position such that they are suitable for connection to the first pair of receiving elements 11 of press ring 10.

FIG. 1-3 shows a second pressing tool 30 having pressing jaws 31, which are rotatably arranged about the axes of rotation D3. The second pressing tool 30 also comprises a pair of connecting elements 32. The connecting elements 32 of the first pressing tool 30 are designed in terms of their shape, dimension and position such that they are suitable for connection to the second pair of receiving elements 12 of press ring 10. In the example shown in FIG. 1, the connecting elements 32 of the second pressing tool 30 are formed as spherical segments for connection to the respective recesses of the second pair of receiving elements 12 of press ring 10.

In the following, identical or similar components are identified by identical reference numerals.

In FIG. 1A-1, press ring 10 and the first pressing tool 20 are shown in engagement with each other, but still in the open position. In FIG. 1A-2, press ring 10 and the first pressing tool 20 are shown in engagement with each other in a closed position, i.e. after pressing has been performed. The connecting elements 22 of the first pressing tool 20 are connected to the first pair of receiving elements 11 of press ring 10. As can be seen in FIG. 1A-3, the pair of connecting elements 22 of the first pressing tool 20 and the first pair of receiving elements 11 of press ring 10 are each matched to one another in terms of their shape, dimension and position such that the connecting elements 22 of the pressing tool, which are formed as an undercut, engage around the first pair of receiving elements 11 of the press ring, which are formed as a bolt. By moving the pressing jaws 21 of pressing tool 20, press ring 10 is transferred from an open position shown in FIG. 1A-1 to a closed position shown in FIG. 1A-2. Here, the distance between the terminal segments 13 is reduced. This reduces the radius of inner opening 14, which is formed by the segments 13, so that a pressing force is transmitted to press fitting 15 and the latter is pressed.

In FIG. 1B-1, press ring 10 and the second pressing tool 30 are also shown in engagement with each other, but still in the open position, whereas in FIG. 1B-2, press ring 10 and the second pressing tool 20 are shown in engagement with each other in a closed position, i.e. after the pressing has been performed. Here, the connecting elements 32 of the second pressing tool 30 are connected to the second pair of receiving elements 12 of press ring 10. In particular, press ring 10 shown in FIG. 1B is the same press ring as in FIG. 1A. As can be seen in FIG. 1B, the pair of connecting elements 32 of the second pressing tool 30 and the second pair of receiving elements 12 of press ring 10 are each matched to one another in terms of their shape, dimension and position such that the connecting elements 32 of the second pressing tool 30, which are spherically formed, engage with the second pair of receiving elements 12 of the press ring, which are each formed as a spherical recess. Here, the movement of the pressing jaws 31 of the second pressing tool 30 also transfers press ring 10 from the open position shown in FIG. 1B-1 to a closed position, which can be seen in FIG. 1B-2. Here, the distance between the terminal segments 13 is also reduced, which reduces the radius of inner opening 14 formed by the segments 13, so that press fitting 15 is pressed by the pressing force transmitted thereto.

FIG. 2 shows a further embodiment of a press ring 40 according to the invention and a first pressing tool 50 suitable for press ring 40 and a second pressing tool 30 suitable for press ring 40. The press ring 40 shown in FIG. 2 also has several segments 43, which are rotatably connected to each other about the axes of rotation D4 and form an inner opening 44. In turn, a first pair of receiving elements 41 and a second pair of receiving elements 42 are each arranged on the first and last segment 43 of press ring 40.

In this case, both the first pair of receiving elements 41 of the embodiment of press ring 40 shown in FIG. 2 and the second pair of receiving elements 42 are formed as a recess of press ring 40. However, as can be seen in FIG. 2-4, the recesses of the first pair of receiving elements 41 of press ring 40 have a different shape and dimension. In particular, the recess of the second pair of receiving elements 42 is arranged in the recess of the first pair of receiving elements. Here, the recess of the first pair of receiving elements 41 has a smaller dimension than the recess of the second pair of receiving elements 42 of press ring 40.

FIG. 2 further shows a first pressing tool 50 suitable for press ring 40, which has two pressing jaws 51 that are rotatably arranged about the respective axes of rotation D5. The first pressing tool 50 further comprises a pair of connecting elements 52 formed as disc-shaped or circular segment-shaped segments. The connecting elements 52 of the first pressing tool 50 are designed in terms of their shape, dimension and position such that they are suitable for connection to the second pair of receiving elements 42 of press ring 40.

Furthermore, FIG. 2 shows a second pressing tool 30 having pressing jaws 31, which are pivotably arranged about the axes of rotation D3. The second pressing tool 30 also comprises a pair of connecting elements 32. The connecting elements 32 of the first pressing tool 30 are designed in terms of their shape, dimension and position such that they are suitable for connection to the first pair of receiving elements 41 of press ring 40. In the example shown in FIG. 2, the connecting elements 32 of the second pressing tool 30 are spherically formed for connection to the respective recesses of the first pair of receiving elements 41 of press ring 40.

As can still be seen in FIG. 2, the recess of the first pair of receiving elements 41 and the recess of the second pair of receiving elements 42 have a common lateral boundary. Here, as shown in FIG. 2A, when the second pair of receiving elements 42 are connected to the pair of connecting elements 52 of the first pressing tool 50, the common lateral boundary serves to limit the movement of the first pressing tool 50. On the other hand, as shown in FIG. 2B, when the first pair of receiving elements 41 are connected to the pair of connecting elements 32 of the second pressing tool 30, the second pressing tool 30 and press ring 40 are rotatable relative to each other.

In FIG. 2A-1, press ring 40 and the first pressing tool 50 are shown in engagement with each other, but still in the open position, whereas in FIG. 2A-2, press ring 40 and the first pressing tool 50 are shown in engagement with each other in a closed position, i.e. after the pressing has been performed.

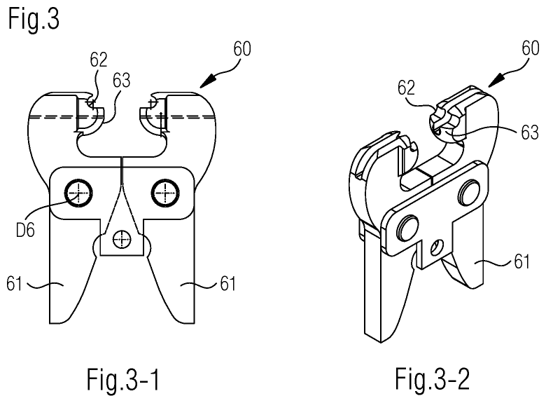

FIG. 2A-3 shows a section through the plane of the connecting elements 52, and FIG. 2A-4 shows a perspective view of press ring 40 and the first pressing tool 50 in the closed position.

In FIG. 2B-1, press ring 40 and the second pressing tool 30 are in turn shown in engagement with each other, but still in the open position, whereas in FIG. 2B-2, press ring 40 and the second pressing tool 30 are shown in engagement with each other in a closed position, i.e. after the pressing has been performed.

FIG. 2B-3 further shows a section through the plane of the connecting elements 32, and FIG. 2B-4 shows a perspective view of press ring 40 and the second pressing tool 30 in the closed position.

FIG. 3 shows a pressing tool 60 according to the invention. As can be seen in FIG. 3, the pressing tool has two pressing jaws 61 which are pivotably arranged about a respective axis of rotation D6 and can thus be moved towards each other from an open position to a closed position during pressing. A first pair of connecting elements 62 and a second pair of connecting elements 63 are arranged on pressing tool 60. The first and second pair of connecting elements 62, 63 are different from each other in terms of shape and dimension. In the embodiment of pressing tool 60 shown in FIG. 3, the first pair of connecting elements 62 is formed as an undercut for connection to a connecting bolt of a known press ring. On the other hand, the second pair of connecting elements 63 of pressing tool 60 is formed as a spherical segment for connection to recesses of another known press ring. Here, as can be seen in FIG. 3, the undercut of the first pair of connecting elements 62 is formed in the spherical segment of the second pair of connecting elements 63 of the pressing tool.

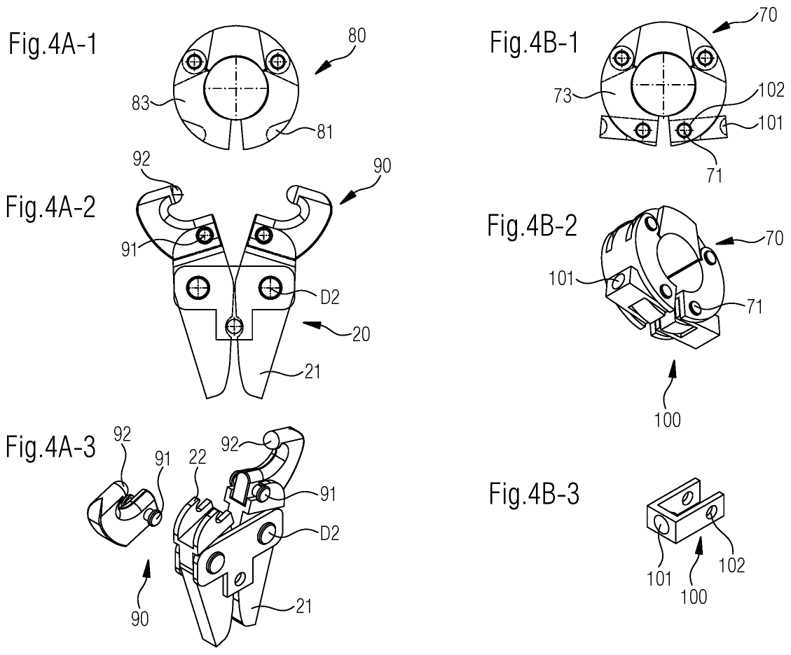

FIG. 4A-2 shows an adapter element 90 according to the invention for a pressing tool 20. Adapter element 90 comprises a first pair of connecting elements 91 and a second pair of connecting elements 92 different therefrom. Here, the first pair of connecting elements 91 serves for connection to a pair of connecting elements 22 of a suitable pressing tool 20, whereas the second pair of connecting elements 92 serves for connection to a pair of receiving elements 81 of a suitable press ring 80, which is shown in FIG. 4A-1. When press ring 80 is correspondingly connected to the pressing tool, by means of the second pair of connecting elements 92 of adapter element 90 connected to receiving element 81, press ring 80 can be moved from an open position to a closed position for pressing a press fitting by transmitting the movement of the pressing jaws 21 to adapter element 90.

In the embodiment shown in FIG. 4A-1, the pair of receiving elements 81 of press ring 80 is formed as a spherical recess for connection to the second pair of connecting elements 92 of adapter element 90 formed as a spherical segment. Here, the first pair of connecting elements 91 of the adapter element is formed as a connecting bolt for connection to the pair of connecting elements 22 of pressing tool 20 shown in FIGS. 4A-2 and 4A-3, the pair of connecting elements 22 of pressing tool 20 being undercuts.

As can be seen in FIG. 4A-3, adapter element 90 comprises two separate components for the respective connecting element of the pair of connecting elements 22 of pressing tool 20.

FIG. 4B-3 shows an adapter element 100 according to the invention for a press ring 70. Adapter element 100 in turn comprises a first pair of connecting elements 101 and a second pair of connecting elements 102 different therefrom. Here, the first pair of connecting elements 101 serves for connection to a pair of connecting elements of a suitable pressing tool, whereas the second pair of connecting elements 102 serves for connection to a pair of receiving elements 71 of a suitable press ring 70 shown in FIGS. 4B-1 and 4B-2. Press ring 70 can then be moved from an open position to a closed position for pressing a press fitting by transferring the movement of the pressing jaws of the pressing tool to adapter element 100 when appropriately connected to a suitable pressing tool.

In the embodiment shown in FIGS. 4B-1 and 4B-2, the pair of receiving elements 71 of press ring 70 is formed as a connecting bolt for connection to the second pair of connecting elements 102 of adapter element 100 formed as a receiving opening. Here, the first pair of connecting elements 101 of the adapter elements is formed as a spherical recess for connection to a pair of connecting elements of a suitable pressing tool, which are formed as spherical segments.

Here, adapter element 100 comprises two separate components for the respective receiving elements of the pair of receiving elements 71 of press ring 70.

1. A press ring for pressing a press fitting, comprising
at least two segments movably connected to each other, the segments being movable from an open position to a closed position, and
wherein the press ring comprises at least a first pair of receiving elements and a second pair of receiving elements,
wherein the first pair of receiving elements is arranged on a first segment and a last segment of the press ring and are each configured for connection to a pair of connecting elements of a first pressing tool, and
wherein the second pair of receiving elements is arranged on the first segment and the last segment of the press ring and are each configured for connection to a pair of connecting elements of a second pressing tool,
wherein the first pair of receiving elements is different from the second pair of receiving elements.

2. The press ring according to claim 1, wherein the first pair of receiving elements are connecting bolts and/or the second pair of receiving elements are recesses.

3. The press ring according to claim 1, wherein the first pair of receiving elements are recesses and the second pair of receiving elements are recesses.

4. The press ring according to claim 3, wherein the recess of the first pair of receiving elements is arranged in the recess of the second pair of receiving elements, wherein the recess of the first pair of receiving elements in particular has a smaller dimension than the recess of the second pair of receiving elements.

5. The press ring according to claim 4, wherein the recess of the first pair of receiving elements and the recess of the second pair of receiving elements have a common lateral boundary, so that when the second pair of receiving elements is connected to a first pair of connecting elements of a first pressing tool, the common lateral boundary serves as a movement limitation for the first pressing tool, whereas, in particular when the first pair of receiving elements is connected to a first pair of connecting elements of a second pressing tool, the second pressing tool and the press ring can be rotated relative to one another.

6. The press ring according to claim 1, wherein the press ring is a press collar which in particular has at least two segments.

7. A pressing tool for pressing a press fitting by means of a press ring, comprising
pressing jaws which can be moved towards each other from an open position to a closed position for pressing,
wherein the pressing jaws comprise at least a first pair of connecting elements and a second pair of connecting elements,
wherein the first pair of connecting elements are each configured for connection to a pair of receiving elements of a first press ring, and the second pair of connecting elements are each configured for connection to a pair of receiving elements of a second press ring,
wherein the first pair of connecting elements is different from the second pair of connecting elements.

8. The pressing tool according to claim 7, wherein the first pair of connecting elements are undercuts for connection to connecting bolts of a press ring.

9. The pressing tool according to claim 7, wherein the second pair of connecting elements are ball segments or spherical segments for connection to recesses of a press ring.

10. The pressing tool according to claim 8, wherein the undercut of the first pair of connecting elements is formed in the ball segment or spherical segment of the second pair of connecting elements.

11. An adapter element for a pressing tool, wherein
the adapter element has a first pair of connecting elements for connection to a pair of connecting elements of a pressing tool, and
has a second pair of connecting elements for connection to a corresponding pair of receiving elements of a press ring, so that when the adapter element is connected to the pressing tool on the one hand and the press ring on the other hand, when the pressing jaws of the pressing tool are moved, this movement is transmitted to the adapter element and the press ring can be moved from an open position to a closed position for pressing a press fitting
wherein the first pair of connecting elements is different from the second pair of connecting elements.

12. An adapter element according to claim 11, wherein the first pair of receiving elements are recesses and/or the second pair of receiving elements are undercuts.

13. An adapter element for a press ring, wherein
the adapter element has a first pair of connecting elements for connection to a corresponding pair of connecting elements of a pressing tool, and
has a second pair of connecting elements for connection to a pair of receiving elements of a press ring, so that when the adapter element is connected to the pressing tool on the one hand and the press ring on the other hand, when the pressing jaws of the pressing tool are moved, this movement is transmitted to the adapter element and the press ring can be moved from an open position to a closed position for pressing a press fitting,
wherein the first pair of connecting elements is different from the second pair of connecting elements.

14. The adapter element according to claim 13, wherein the first pair of receiving elements are connecting bolts and the pair of receiving elements are ball segments or spherical segments.

15. A pressing device comprising an electric drive and a pressing tool according to claim 7, wherein the pressing tool is connected to the drive for moving the pressing jaws of the pressing tool.

16. A system comprising a press ring according to claim 1 and a pressing device having a drive.

17. The system comprising an adapter element according to claim 11 and a press ring and a pressing device.
